(19) United States
(12) Patent Application Publication
(10) Pub. No.: US 2010/0043558 A1
(43) Pub. Date: Feb. 25, 2010

(54) Tuned Resonant Apparatus for Non-Destructive Testing or Flaw Analysis

(76) Inventor: Rolly E. Fuller, Benton City, WA (US)

Correspondence Address: FLOYD E. IVEY;IVEY Law Offices, P.S. Corp., 7233 W. Deschutes Ave., Suite C, BOX #3, KENNEWICK, WA, 99336, US

(21) Appl. No.: 12/194,520

(22) Filed: Aug. 19, 2008

(51) Int. Cl. G01N 29/26; G01N 29/24

(52) U.S. Cl. 73/620; 73/627

(57) ABSTRACT

A Tuned Resonant Insert TRI (1), is disclosed for Non Destructive Testing (NDT) which eliminates the need for a couplant, either solid or liquids including demineralized water and oils. The TRI (1) applies a tip force on a uni-morph or bi-morph ceramic with a range of 0.03 lbf to 4.0 lbf. The frequency range is 1 kHz to 6 MHZ. The preferred material type for the tip is Ultem. The length and diameter of the tip is sized to achieve optimal tip acoustical resonance for use with specific material and can range from 0.620 to 1.200 inches for the length and 0.100 to 0.400 inches for the diameter. A probe housing will house at least one TRI (1) and, in different embodiments “n” TRI (1) units. Constant force tip contact minimizes acoustical impedance at the tip to material interface, allowing for increased sensitivity without the use of a couplant.

### BACKGROUND OF THE INVENTION

Non-Destructive Testing (NDT) commonly employs a device, or probe, which receives an input, such as an electrical initiating pulse, from an instrument. A ceramic within the probe converts the electrical initiating pulse into an acoustic initiating pulse and transmits that acoustic initiating pulse into a material. A return acoustic wave is generated from within the material. The return acoustic wave can be of differing magnitude depending on whether or not the original acoustic initiating pulse encounters a “defect” within the material or not. The acoustic return pulse is detected by the probe, converted by the ceramic into an electrical pulse which is communicated to the instrument. In many instances the probe is coupled with the material via a liquid including water or oil.

### SUMMARY OF THE INVENTION

A Tuned Resonant Insert, comprising an Apparatus and abbreviated hereafter as TRI, is disclosed for Non Destructive Testing (NDT) which eliminates the need for a couplant, either solid or liquids including demineralized water and oils. The TRI, for NDT, is used to perform non-destructive testing or flaw analysis in various materials where the presence or absence of such flaw is unknown. The method uses pulse-echo and pitch-catch ultrasonic technology. The TRI is particularly advantageous in performing analysis of various laminated materials to determine disbanding between the material interfaces without the use of a couplant. Most common couplants are water or oil. The laminated materials include the following but not necessarily are all inclusive: all varieties of woods, plastics, fiberglass, metals, graphite composites, aggregates, concrete and effectively all other materials that can have voids or bonding interfaces with any other material, including those listed above, and with itself.

Any of these materials are known to be resistant to well understood means of interrogation, which include the techniques and devices both requiring and not requiring the use of couplants. A common means of interrogation include resonant probe and scalar imaging, but require use of a couplant, e.g., water or oils, to achieve the minimally desired sensitivity and depth of penetration. Couplants are generally not desirable because of the time consuming nature to apply and remove, and the sometimes unknown chemical interaction that could occur with the material being examined. TRI does not require the use of a couplant to identify flaws of an unacceptable size. The probe structure disclosed here has a greatly improved signal to noise ratio over prior NDT probes including probes not requiring couplants.

The TRI is fabricated from readily available materials in very precise dimensional tolerances and assembly configuration, e.g., interfacing component pressures, not heretofore used. Using pulse-echo or pitch-catch electronics, the results are significantly higher levels of sensitivity, e.g., 1000 times greater than current pitch-catch and pulse-echo probes without couplant, much higher signal-to-noise ratio, and increased depth of penetration to detect flaws by approximately 2 to 3 times depending upon material type.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIGS. 1, 2 and 3 illustrate the Tuned Resonance Insert (FIG. 1) in an exploded view, as assembled (FIG. 2) and in section (FIG. 3). Illustrated is the Tuned Resonance Insert showing the TRI Holder (1000), the holder (1100), holder axis (1105), holder first end (1120), holder second end (1130), holder second end aperture (1135) which represents a set screw as example of a method of retaining the components together with the set screws received into “set screw” groove seen in FIGS. 5 and 6, the primary cavity (1140), primary cavity threads (1145), “O” ring recess (1148), “O” ring (1150), ceramic (1154), ceramic lead connections (1156) and ceramic output wires (1158). Also seen is a tri-cap (1160), tri-cap aperture (1162), tri-cap top (1164), tri-cap extension (1166) and tri-cap extension threads (1168). Also illustrated is the tip (1170), tip first end (1172), tip stabilizing disk (1174), tip second end (1176), tip nose (1178) and spring (1180). Also seen is the tri-body (1190), the tri-body first end (1192), the tri-body second end (1194), the tri-body aperture (1196), the tri-body cap (1198) and tri-body cap aperture (1199). Also shown is the secondary cavity (1200).

FIGS. 4, 4A, 5, 5A, 6, 6A, 7 and 7A illustrate variants of housings which will present at least one TRI (1) to a surface. A probe structure will house one to multiple TRI Assemblies as depicted in FIGS. 4 through 7, depending upon the width of the housing. The probe housing may be constructed of varying widths to provide the capability of acoustical scanning a material without couplant of correspondingly varying widths depending on the width of the probe housing.

FIGS. 8, 8A and 8C are block diagrams illustrating the electrical circuits. FIG. 8 shows the user's instrument (2000) which provides the electrical initiating pulse to the ceramic (1154), the output from the ceramic (1154) is the acoustic initiating pulse (2200). The return acoustic wave (2300) is received by the ceramic (1154) which emits a return electrical pulse (2400) to the instrument (2000). FIG. 8A illustrates a variation on the circuit of FIG. 8 where duel TRI (1) units are employed, one to transmit the acoustic initiating pulse (2200) and a second to receive the return acoustic wave (2300), communicate the return acoustic wave (2300) to the ceramic (1154) which in turn generates the return electrical pulse (2400) to the instrument (2000). FIG. 8A also illustrates an alarm output (2500) from the instrument (2000) which initiates an alarm, shown in FIG. 7 as an LED alarm (2600)

FIG. 9 illustrates the “sequencer” circuit and FIG. 10 illustrates the alarm circuit seen in FIG. 8B.

### DETAILED DESCRIPTION

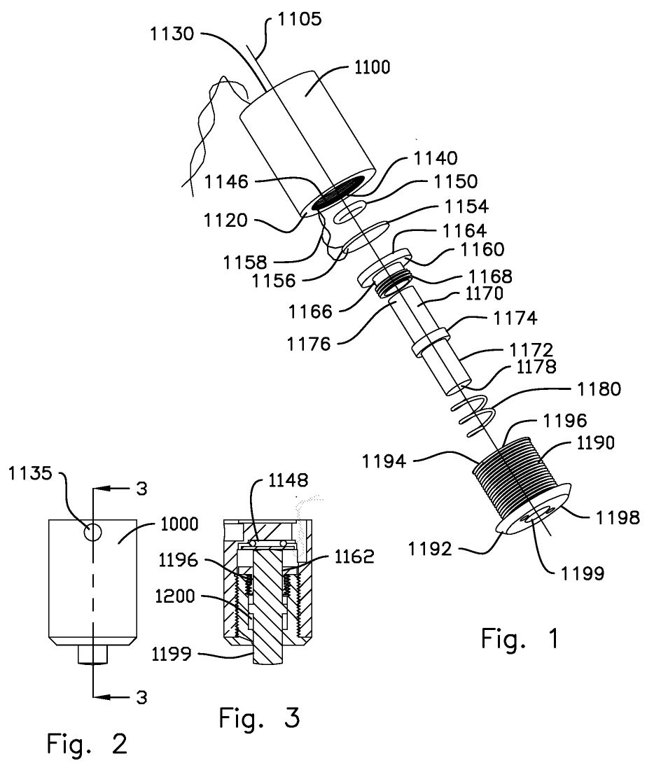

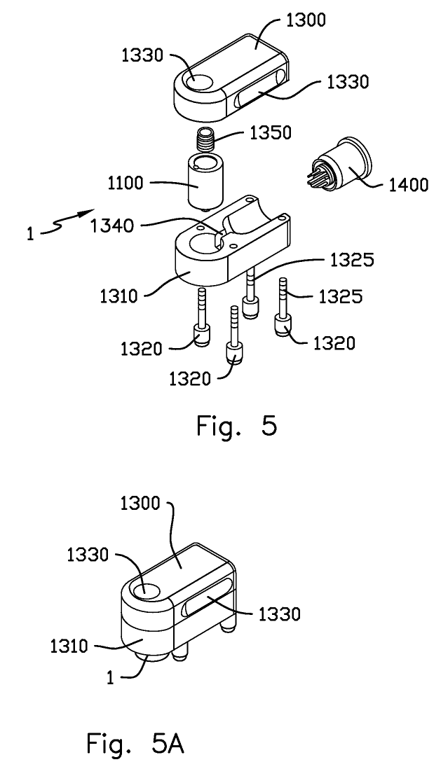

A non-destructive defect examination structure or TRI Assembly (1) as depicted in FIGS. 1, 2, 3, 4, 5, 6 and 7 and with the following physical characteristics to give the assembly acoustic properties sufficient to propagate acoustic energies into acoustically resistant materials that allow a connected ultrasonic instrument to measure variations in returning acoustic signals that represent material flaws below the surface with acoustic spectra exhibiting a high signal to background noise ratio.

The primary physical characteristics of the TRI (1) that work together to apply a tip (1176) force on the ceramic (1154) with a range of 0.03 lbf to 4.0 lbf and further limited to a narrower range of 1.5 lbf to 2.5 lbf and, in the preferred embodiment the preferred force is 2 lbf. The ceramic (1154) is a piezo-electric acoustic emitter that may be uni-morph or bi-morph with the preferred being bi-morph. The frequency range is 1 kHz to 6 MHZ and is narrowed further from 6 kHz to 40 kHz. The ceramic diameter may range from 0.25-inch to 1.0-inch and is narrowed further from 0.325-inch to 0.405-inch with the preferred diameter being 0.375-inch. The thickness may range from 0.012-inch to 0.325-inch and is narrowed further from 0.019-inch to 0.023-inch with the preferred thickness being 0.021-inch.

The tip end (1176) in contact with the ceramic (1154) may range from a perfect flat surface to a conical point with the preferred being flat within a spherical arc tolerance of ±2 degrees. The tip end (1178) in contact with the material being examined may range from a perfect flat surface to a conical point with the preferred being flat within a spherical arc tolerance of ±2 degrees.

The acceptable clearances between the diameter of the tip land (1174) and the inner diameter of the TRI Body spring housing (1196), the diameter of the lower tip portion (1172) and the inner diameter of the TRI Body nose (1199), and the diameter of the upper tip portion (1176) and the inner diameter of the TRI Cap (1162) ranges from 0.001-inch to 0.005-inch with the preferred clearance being 0.0025-inch to prevent tip (1170) slap against the TRI body (1190) that results in unwanted acoustical noise. The Buna-N o-ring backing (1150) with a compressibility of up to 0.015-inch with a range of 1.5 lbf to 2.5 lbf but preferred at 2 lbf on the ceramic (1154) to maximize the reverberation of the ceramic (1154), and thus, maximize the acoustical transmission through the tip (1170) and minimize loss of the returning acoustical response from the material through the tip (1170) to the ceramic (1154).

The ceramic (1154) is placed against the o-ring (1150) inside the TRI Holder (1148). The TRI spring (1180) length is nominally 0.250 inches long ±0.125 inches with a spring constant 1.2±0.1 lbs/inch. The tip land (1174) is preferably 0.250±0.1625 inches from the ceramic end of the tip (1176), but can be adjusted for tip (1170) length, and the width of the land (1174) is preferably 0.050±0.030 inches with a workable range from 0.020 inches to 0.080 inches. The length of the TRI Body (1190) from the inside face of the TRI cap (1192) that mates with the TRI Holder (1120) to the threaded end of TRI Body (1194) ranges from 0.380-inch to 0.420-inch, but is preferably 0.400-inch and may be adjusted with changes in tip length. The preferred material type for the tip (1170) is Ultem to achieve the desired acoustic transmission, and ease of fabrication to achieve required tolerances and durability. Other materials may include Delrin, Aluminum, Brass, Stainless Steel, ABS plastic and Acrylic. The length and diameter of the tip (1170) is sized to achieve optimal tip acoustical resonance for use with specific material and can range from 0.620 to 1.200 inches for the length and 0.100 to 0.400 inches for the diameter dependent upon the material type being examined. The preferred material types for the TRI Body, TRI Cap and TRI Holder are Brass, Brass, and Delrin, respectively. Aluminum, Ultem and Stainless Steel are also used depending on environmental conditions.

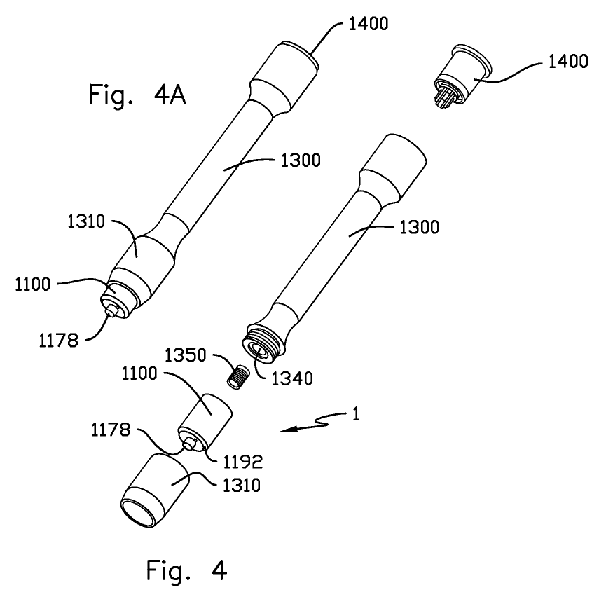

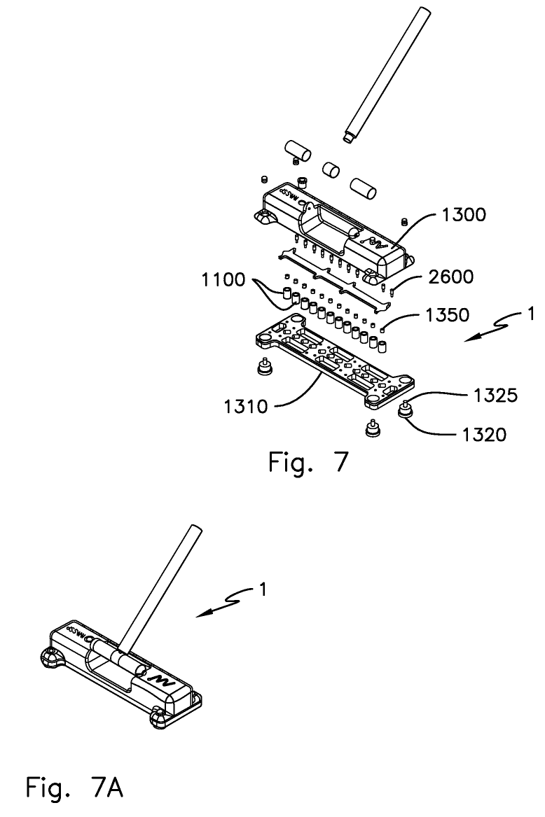

A probe housing (1300) will house at least one TRI (1) and, in different embodiments “n” TRI (1) units as depicted in FIGS. 4 through 7. The probe housing (1300) may be constructed of varying widths to provide the capability of acoustical scanning a material without couplant of correspondingly varying widths depending on the width of the probe housing. Multiple TRI Assemblies (1) are installed in a straight line at the preferred center-to-center distance or pitch of 0.7-inch. The acceptable pitch range can be from 0.6-inch to 1.2-inches. The installed TRI Assembly (1) into a probe housing (1300) provides for up to ½-inch movement of the TRI Assembly (1) in the probe housing socket (1340). The TRI Assembly (1) is spring loaded with a housing spring (1350) and captured in the probe housing socket (1340) by a set screw or snap spring or the equivalent to allow for housing spring (1350) return movement. This together with the probe feet (1320) ensures constant force contact of the tip nose (1178) with slight to moderate changing surface profiles of the material being examined. The probe feet (1320) may terminate in a roller configuration which is of particular application for the configuration depicted in FIG. 7 and 7A. This constant force tip (1178) contact minimizes acoustical impedance at the tip (1178) to material interface, allowing for increased sensitivity without the use of a couplant.

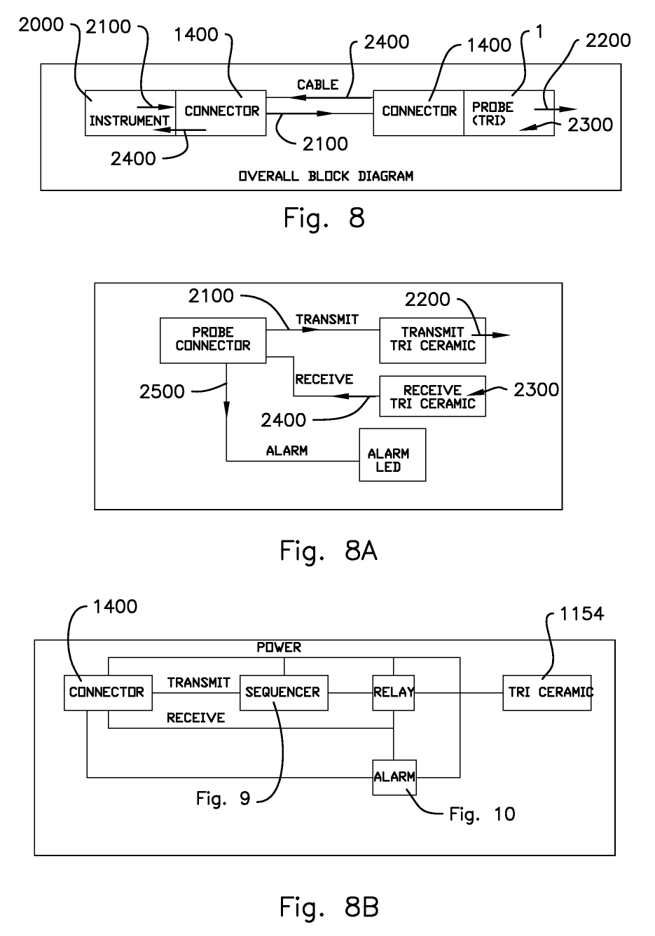

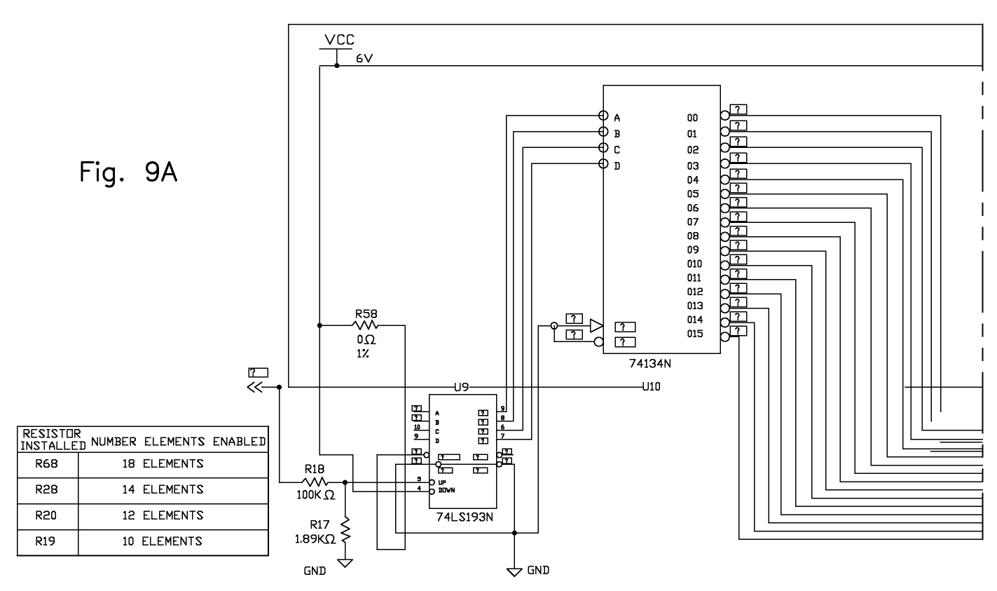

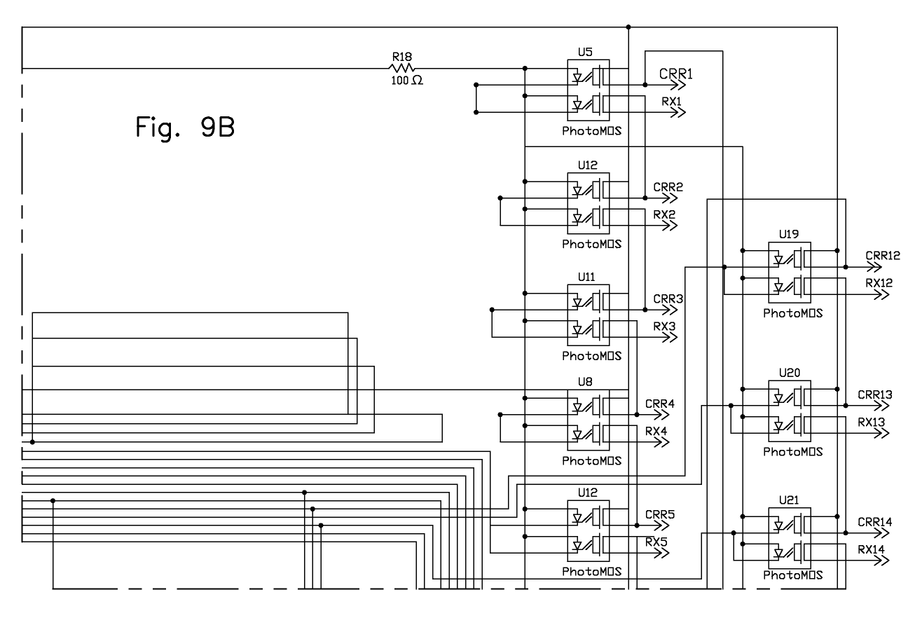

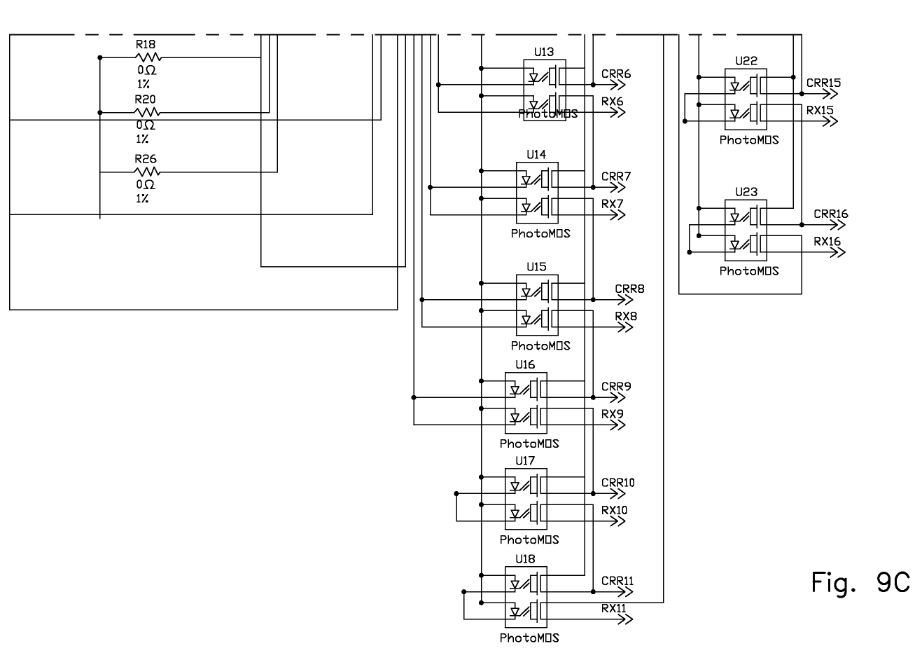

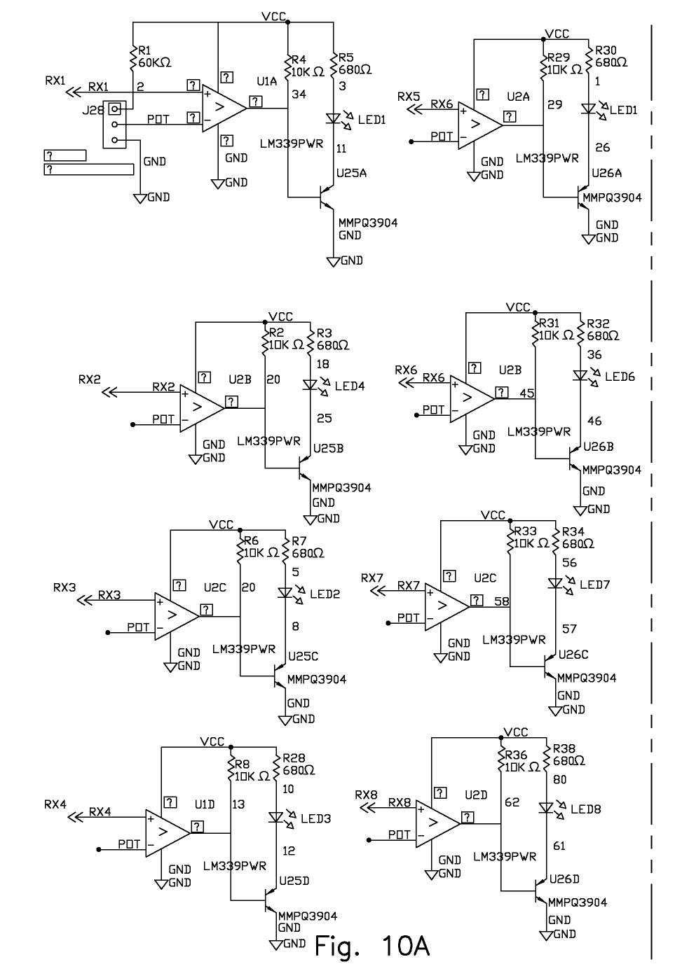

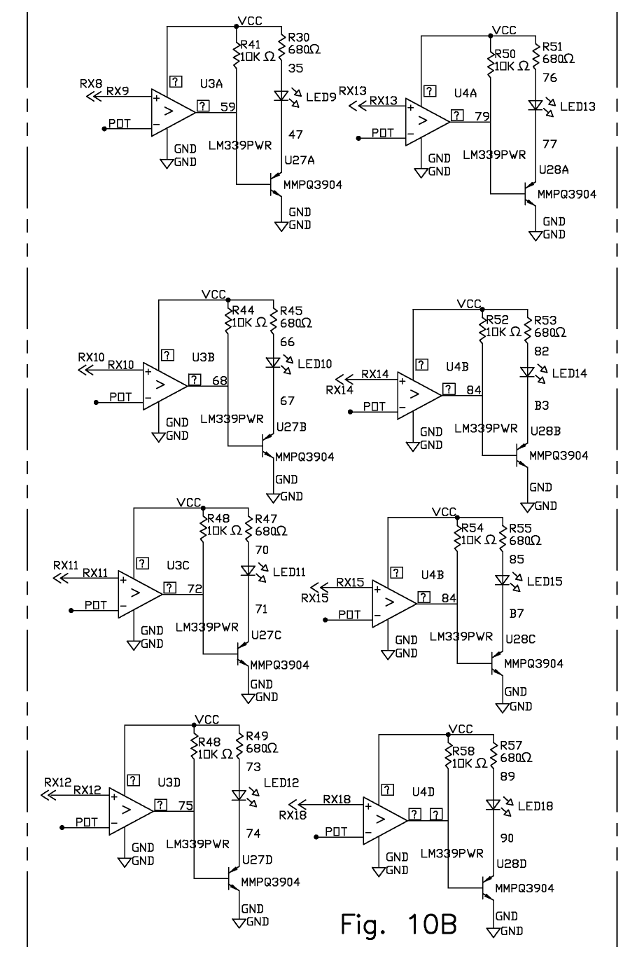

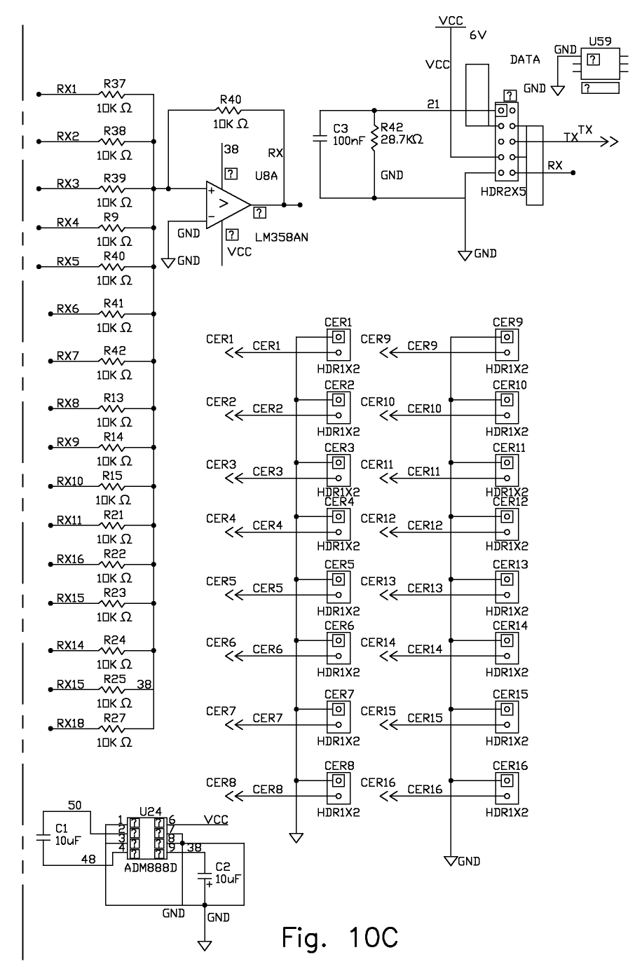

The installed TRI Assembly (1) ceramic lead wires (1158) are nominally of insulated 24 gauge wire which are soldered to on-board probe circuit board terminals seen in FIG. 9 and 10. The on-board circuit board, FIG. 9 or 10, provides for signal amplification, filtering and sequencing as appropriate to maximize signal to noise ratio. Per the schematics in FIGS. 8 and 9, leads from the onboard circuit board are soldered to the appropriate pins of the probe housing connector. An interface cable is then attached at one end to the probe connector (1400) and the other to the instrument connector. The instrument (2000) sends a signal to the ceramic (1154) via the interface cable and onboard circuit FIG. 9 or 10. The ceramic (1154) emits an acoustical wave (2200) into the examining material through the TRI tip (1178). The material sends a reflecting wave back of differing magnitude depending on the specific material and discontinuities or defects. The reflecting wave is picked up by the TRI tip (1178) and transmitted to the ceramic as the return acoustic pulse (2300). The pulsation of the ceramic (1154) with a magnitude corresponding to the reflected wave generates a return electrical pulse (2400) signal that is sent back to the instrument via the on-board circuit and interface cable. The instrument compares the differences of reflected waves. A significant difference indicates a discontinuity or defect.

The on-board circuit, seen in FIGS. 9 and 10, for the Wide Area Sonic Sweep Probe (WASSP™) shown in FIGS. 7 and 7A sequences the initiating electrical pulse from the instrument to the TRIs (1) in the WASSP™ and channels an adjacent TRI (1) returning signal back to the instrument, which represents the pitch-catch ultrasonic signal methodology. This circuit will sequence the pitch-catch signals to and from each overlapping pair of TRIs in the WASSP™ continuously for multiple TRI Assemblies (1) up to “n” assemblies. FIG. 7 illustrates 16 TRI Assemblies (1). This circuit does not have the capability of receiving pulse-echo signals.

The probe housing (1300) variant seen in FIGS. 7 and 7A presents multiple TRIs (1) that are sequenced constantly from one end to the other. The TRI tips (1178) must be sequenced to reduce noise during flaw detection. A general description of the schematic and sequencing procedure, illustrated in FIG. 9, is as follows: The schematic on FIG. 9 consists of three main components.
1. 74LS 193N, Synchronous 4-bit binary counter
2. 74154N, 4-line to 16-line decoder
3. PhotoMos Optocoupler

The 74LS 193N is triggered by the falling edge of the instruments (2000) signal (2100). As the counter is triggered, the binary outputs are fed into the 74154 to be decoded. The 74154 inputs are continuously counting 0-15 or “0-n” which causes the outputs 0-15 or “0-n” to be selected one at a time. The 16 or “n” outputs activate the 16 or “n” PhotoMos switches one at a time which allows the signals at the ceramics to be passed to the second schematic through the summing amplifier (LM358AN) and to the instrument.

The signals from the ceramics (Transmit & Receive) are passed to the input of the circuit comprised of the LM339, 2N3904 and LED seen in FIG. 10. This circuit on schematic FIG. 10 is a window comparator. The comparator samples the signal from the ceramic receive and flashes the LED when a predetermined voltage level is reached. This simulates an alarm effect. The alarm set point is set by a potentiometer identified on schematic FIG. 10 as the ‘BM Gate Pulse’. There is a screw adjustment located on WASSP™ housing to adjust the alarm setpoint.

The ADM8660, seen in FIG. 10, is a DC converter which uses the 6 volts from the instrument (2000) and produces both a positive and negative 6 volts which is needed to power dual polarity operational amplifiers. The DS2505 is an EPROM and is used for identification for the instrument (2000). As the instrument (2000) is turned on, it reads the DS2505. The DS2505 has information programmed that tells the instrument (2000) what kind of probe is being used and the instrument will be initialized accordingly.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A non-destructive defect examination structure or TRI Assembly as depicted in FIGS. 1, 2 and 3 and with the following physical characteristics to give the assembly acoustic properties sufficient to propagate acoustic energies into acoustically resistant materials that allow a connected ultrasonic instrument to measure variations in returning acoustic signals that represent material flaws below the surface with acoustic spectra exhibiting a high signal to background noise ratio
a. Apply a tip (1176) force on the ceramic (1154) with a range of 0.03 lbf to 4.0 lbf and further limited to a narrower range of 1.5 lbf to 2.5 lbf and the preferred force being 2 lbf.
b. The ceramic (1154) is a piezo-electric acoustic emitter that may be uni-morph or bi-morph with the preferred being bi-morph. The frequency range is 1 kHz to 6 MHZ and is narrowed further to 6 kHz to 40 kHz. The diameter may range from 0.25-inch to 1.0-inch and is narrowed further to 0.325-inch to 0.405-inch with the preferred diameter being 0.375-inch. The thickness may range from 0.012-inch to 0.325-inch and is narrowed further to 0.019-inch to 0.023-inch with the preferred being 0.021-inch.
c. The tip end (1176) in contact with the ceramic (1154) may range from a perfect flat surface to a conical point with the preferred being flat within a spherical arc tolerance of ±2 degrees.
d. The tip end (1178) in contact with the material being examined may range from a perfect flat surface to a conical point with the preferred being flat within a spherical arc tolerance of ±2 degrees.
e. The acceptable clearances between the diameter of the tip land (1174) and the inner diameter of the TRI Body spring housing (1196), the diameter of the lower tip portion (1172) and the inner diameter of the TRI Body nose (1199), and the diameter of the upper tip portion (1176) and the inner diameter of the TRI Cap (1162) ranges from 0.001-inch to 0.005-inch with the preferred clearance being 0.0025-inch to prevent tip (1170) slap against the TRI body (1190) that results in unwanted acoustical noise.
f. The Buna-N o-ring backing (1150) with a compressibility of up to 0.015-inch with a range of 1.5 lbf to 2.5 lbf but preferred at 2 lbf on the ceramic (1154) to maximize the reverberation of the ceramic (1154), and thus, maximize the acoustical transmission through the tip (1170) and minimize loss of the returning acoustical response from the material through the tip (1170) to the ceramic (1154).
g. The ceramic (1154) is placed against the o-ring (1150) inside the TRI Holder (1148).
h. The TRI spring (1180) length is nominally 0.250 inches long ±0.125 inches with a spring constant 1.2±0.1 lbs/inch.
i. The tip land (1174) is preferably 0.250±0.1625 inches from the ceramic end of the tip (1176), but can be adjusted for tip (1170) length, and the width of the land (1174) is preferably 0.050±0.030 inches with a workable range from 0.020 inches to 0.080 inches.
j. The length of the TRI Body (1190) from the inside face of the TRI cap (1192) that mates with the TRI Holder (1120) to the threaded end of TRI Body (1194) ranges from 0.380-inch to 0.420-inch, but is preferably 0.400-inch and may be adjusted with changes in tip length.
k. The preferred material type for the tip (1170) is Ultem to achieve the desired acoustic transmission, and ease of fabrication to achieve required tolerances and durability. Other materials may include Delrin, Aluminum, Brass, Stainless Steel, ABS plastic and Acrylic.
l. The length and diameter of the tip (1170) is sized to achieve optimal tip acoustical resonance for use with specific material and can range from 0.620 to 1.200 inches for the length and 0.100 to 0.400 inches for the diameter dependent upon the material type being examined.
m. The preferred material types for the TRI Body, TRI Cap and TRI Holder are Brass, Brass, and Delrin, respectively. Aluminum, Ultem and Stainless Steel are also used depending on environmental conditions.
n. The TRI may be used with pitch-catch or pulse-echo signal source.
o. The TRI requires no couplant interface between the TRI tip and material being examined.

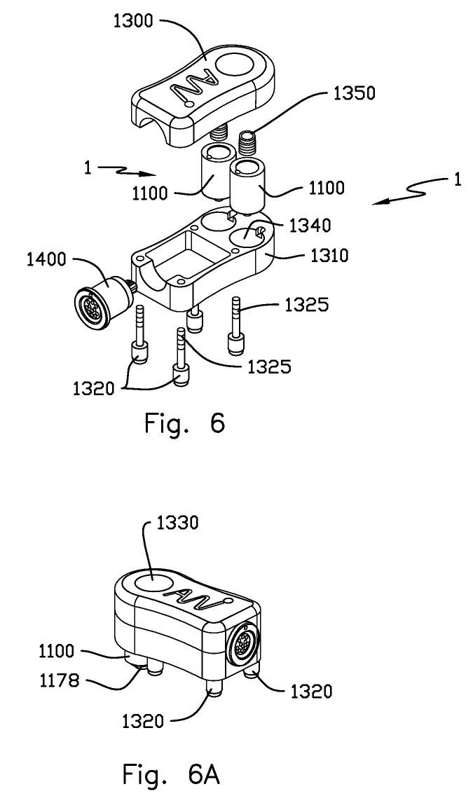

2. A probe structure will house one to multiple TRI Assemblies as depicted in FIGS. 4 through 7, depending upon the width of the housing. The probe housing may be constructed of varying widths to provide the capability of acoustical scanning a material without couplant of correspondingly varying widths depending on the width of the probe housing.
a. Multiple TRI Assemblies are installed in a straight line at the preferred center-to-center distance or pitch of 0.7-inch. The acceptable pitch range can be from 0.6-inch to 1.2-inches.
b. The installed TRI Assembly into a probe housing provides for up to ½-inch movement of the TRI Assembly in the probe housing socket. The TRI Assembly is spring loaded and captured in the housing socket to allow for spring return movement. See FIG. 2 for a typical assembly. This ensures constant force contact of the tip with slight to moderate changing surface profiles of the material being examined. This constant force tip contact minimizes acoustical impedance at the tip to material interface, allowing for increased sensitivity without the use of couplant.
c. The installed TRI Assembly ceramic lead wires are soldered to on-board probe circuit board terminals. The on-board circuit board provides for signal amplification, filtering and sequencing as appropriate to maximize signal to noise ratio. Per the schematics in FIG. 6, leads from the onboard circuit board are soldered to the appropriate pins of the probe housing connector. An interface cable is then attached at one end to the probe connector and the other to the instrument connector. The instrument sends a signal to the ceramic via the interface cable and onboard circuit. The ceramic emits an acoustical wave into the examining material through the TRI tip. The material sends a reflecting wave back of differing magnitude depending on the specific material and discontinuities or defects. The reflecting wave is picked up by the TRI tip and transmitted to the ceramic. The pulsation of the ceramic with a magnitude corresponding to the reflected wave generates a signal that is sent back to the instrument via the on-board circuit and interface cable. The instrument compares the differences of reflected waves. A significant difference indicates a discontinuity or defect.
d. The claims in Item 2 together with the claims in Item 1 above yield up to 1000 times more sensitivity than the current art without the use of couplant.
e. In addition, the WASSP™ will scan as much as 36 times wider area and more in a single motion without couplant than the current art that requires couplant.
